(19) United States
(12) Patent Application Publication
(10) Pub. No.: US 2020/0372779 A1
(43) Pub. Date: Nov. 26, 2020

(54) TERMINAL DEVICE, RISK PREDICTION METHOD, AND RECORDING MEDIUM

(71) Applicant: NEC CORPORATION, Tokyo (JP)

(72) Inventor: Masato MORIYA, Tokyo (JP)

(73) Assignee: NEC Corporation, Tokyo (JP)

(21) Appl. No.: 16/634,253

(22) PCT Filed: Jul. 20, 2018
(86) PCT No.: PCT/JP2018/027371

§ 371 Date: Jan. 27, 2020

(30) Foreign Application Priority Data
Jul. 28, 2017 (JP) 2017-146960

(51) Int. Cl. G08B 21/04

(52) U.S. Cl. CPC G08B 21/0423; G08B 21/0446; G08B 21/0476; G08B 21/0469

(57) ABSTRACT

The purpose of the present invention is to provide a terminal device capable of predicting higher risks. The terminal device determines whether a user is operating a device while walking; collects ambient sound; and, if it is determined that the user is operating the device while walking, predicts a risk to the user on the basis of a risk object candidate captured in image data obtained from a camera with which the terminal device is equipped. The terminal device also calculates the direction of a sound generating source on the basis of a sound signal obtained from a sound collection device.

### TECHNICAL FIELD

The present invention relates to a terminal device, a risk prediction method, and a recording medium.

### BACKGROUND ART

PTL 1 discloses a technique related to risk avoidance for a user who uses a terminal device while walking. In the technique of PTL 1, a moving speed of the terminal device is derived, and an activation state of a display screen is determined. Further, according to the technique, a first image shooting means is provided on a display screen side, an orientation of a face of a user is determined, based on a shot image acquired from the first image shooting means, and it is determined whether or not the user is walking while viewing the terminal device, based on a moving speed of the terminal device, an activation state, and an orientation of the face. Furthermore, in the technique of PTL 1, when a user is walking in a state of viewing the terminal device, it is determined whether or not the user is in a risky situation, based on a frequency or volume of collected sound.

### CITATION LIST

### Patent Literature

[PTL 1] Japanese Unexamined Patent Application Publication No. 2014-232411

### SUMMARY OF INVENTION

### Technical Problem

There is a need for a technique capable of predicting a higher risk in risk prediction for a pedestrian in the technique as described above.

In view of the above, an object of the present invention is to provide a terminal device, a risk prediction method and a program that solve the above-described problem.

### Solution to Problem

According to the first aspect of the present invention, a terminal device comprises while-walking operation determination means for determining whether a user is operating an own device while walking; a sound collection device that collects a surrounding sound; and risk prediction means for, when it is determined that the user is operating an own device while walking, predicting a risk to the user, based on a risk object candidate included in image data acquired from a camera provided in an own device, wherein the risk prediction means calculates a direction of a generation source of the sound, based on a sound signal acquired from the sound collection device.

According to the second aspect of the present invention, a risk prediction method comprises: determining whether a user is operating an own device while walking; collecting a surrounding sound; and, when it is determined that the user is operating an own device while walking, predicting a risk to the user, based on a risk object candidate included in image data acquired from a camera provided in a terminal device, and calculating a direction of a generation source of the sound, based on a signal of the collected sound.

According to the third aspect of the present invention, a recording medium that stores a program causing a computer of a terminal device to function as: while-walking operation determination means for determining whether a user is operating an own device while walking; sound collection means for collecting a surrounding sound; and risk prediction means for, when it is determined that the user is operating an own device while walking, predicting a risk to the user, based on a risk object candidate included in image data acquired from a camera provided in the terminal device, and calculating a direction of a generation source of the sound, based on a signal of the collected sound.

### Advantageous Effects of Invention

According to the present invention, it is possible to provide a technique capable of predicting a higher risk in risk prediction for a pedestrian who is walking while holding a terminal device.

### BRIEF DESCRIPTION OF DRAWINGS

FIG. 1 is a block diagram of a terminal device according to one example embodiment of the present invention.

FIG. 2 is a function block diagram of the terminal device according to the one example embodiment of the present invention.

FIG. 3 is a processing flow of the terminal device according to the one example embodiment of the present invention.

### EXAMPLE EMBODIMENT

Hereinafter, a terminal device according to one example embodiment of the present invention is described with reference to the drawings.

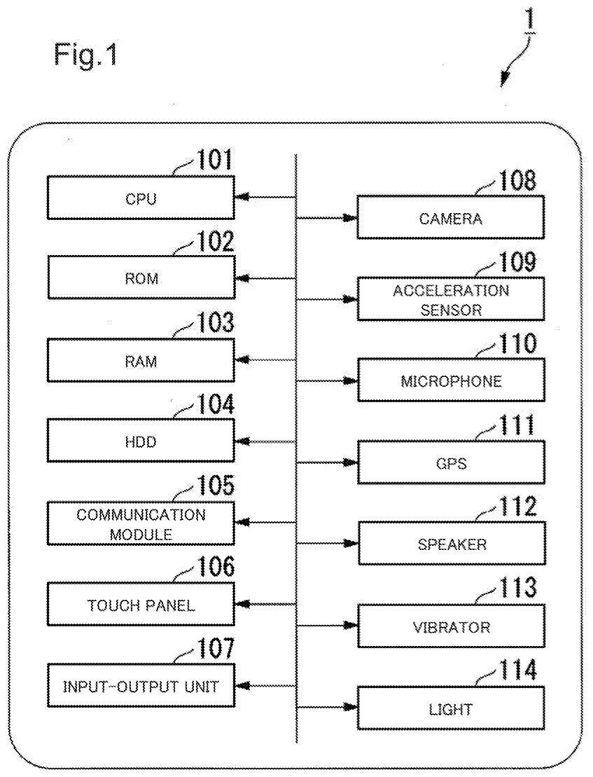

FIG. 1 is a block diagram illustrating a configuration of the terminal device according to the present example embodiment.

The terminal device 1 is a portable terminal such as a smartphone, a mobile phone, a PDA, and a tablet terminal. The terminal device 1 includes hardware such as a CPU 101, a ROM 102, a RAM 103, an HDD 104, a communication module 105, a touch panel 106, an input-output unit 107, a camera 108, an acceleration sensor 109, a microphone 110, a GPS 111, a speaker 112, a vibrator 113, and a light 114.

The terminal device 1 according to the present example embodiment predicts or detects a risk to a user who is operating his or her own terminal while walking, and notifies the user of the risk. Thereby, the terminal device 1 supports avoidance from the risk to the user who is making operation while walking.

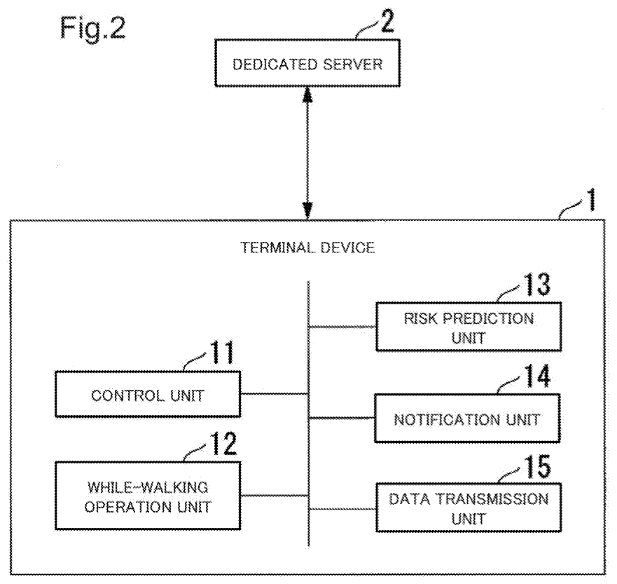

FIG. 2 is a function block diagram of the terminal device.

The terminal device 1 includes at least function units that are a control unit 11, a while-walking operation determination unit 12, a risk prediction unit 13, a notification unit 14, and a data transmission unit 15 by being activated and executing a control program. The terminal device 1 includes other known functions such as a telephone function. The control unit 11 controls each function unit provided in the terminal device 1. The while-walking operation determination unit 12 determines whether or not a user is operating the terminal device 1 while walking. The risk prediction unit 13 predicts or detects a risk to a user who is making operation of the terminal device 1 while walking. The notification unit 14 makes notification of the risk to a display function such as the touch panel 106 of the terminal device 1. The data transmission unit 15 transmits data to a communicatively connected device.

Next, details of each function of the terminal device 1 are described.

The while-walking operation determination unit 12 combines information acquired from various pieces of hardware such as the acceleration sensor 109 illustrated in FIG. 1, and determines whether a user is making operation while walking. For example, the while-walking operation determination unit 12 determines whether operation is being made while walking, based on determination of whether a screen configured by the touch panel 106 is in an on-state, determination of whether a detected pattern of the acceleration sensor 109 matches a walking pattern, a determination of whether a characteristic object detected in an image acquired from the camera 108 is moving, and the like. More specifically, when determining that the screen is in an on-state, an acceleration pattern detected by the acceleration sensor 109 matches the walking pattern, and the characteristic object is moving in the image, the while-walking operation determination unit 12 determines that operation is being made while walking.

The risk prediction unit 13 combines the various functions such as the camera 108, the microphone 110, the acceleration sensor 109, and the GPS 111 incorporated in the terminal device 1, and predicts a risk to the user in real time. In the prediction of a risk, the risk prediction unit 13 uses positional information of the terminal device 1 acquired from the GPS 111, posture information such as an orientation of the terminal device 1 based on an acceleration acquired from the acceleration sensor 109, and image data acquired by image shooting of the camera 108, a sound signal acquired from the microphone 110, and the like. The camera 108 may be constituted by a plurality of cameras such as an in-camera 108a and an out-camera 108b, and these cameras 108 may be all-sky cameras. A plurality of the microphones 110 may be provided in the terminal device 1.

The terminal device 1 described in the present example embodiment is provided with the touch panel 106 in which a liquid crystal screen and a touch sensor are stacked in a main surface of a plate-shaped housing. The in-camera 108a is provided at a portion that is in the main surface and that is on an upper side of the touch panel 106. Further, the out-camera 108b is provided at an upper portion in a back surface opposite to the main surface. The in-camera 108a is a camera whose image shooting direction is oriented to a user when the user orients the touch panel 106 of the terminal device straight to the user. When the user orients, to himself or herself, the main surface of the housing of the terminal device 1 including the touch panel, the in-camera 108a is thereby and necessarily at a position of shooting an image in the direction to the user. Meanwhile, the out-camera 108b is a camera whose image shooting direction is oriented in a direction opposite to the side of the user himself or herself, i.e., in an advancing direction of the user when the user orients the touch panel 106 of the terminal device 1 to himself or herself.

The risk prediction unit 13 recognizes a direction of a sound by using a plurality of microphones 110. Further, the risk prediction unit 13 may detect an orientation of the terminal by using image data acquired by image shooting of the camera 108, or may predict a risk to a user, based on information included in the image data while correcting distortion or the like of the image data, based on a reference mark included in the image data.

The notification unit 14 makes notification of a risk to the screen of the terminal device 1, and further notifies the user of a risk by using various functions provided in the terminal device 1 such as the speaker 112, the vibrator 113, and the light 114, and prompts the user to take a risk avoidance action. Not limited to the case of detecting a risk, the notification unit 14 may display information on obstacle and the like on the screen in real time.

Note that in the present invention, the terminal device 1 may be configured in such a way that the risk prediction unit 13 always predicts a risk, instead of processing of the while-walking operation determination unit 12. Further, the terminal device 1 may include the data transmission unit 15, and may transmit a risk prediction result acquired by the risk prediction unit 13 to a communicatively connected dedicated server. The dedicated server may accumulate information of risk prediction results acquired by the terminal device 1, calculate basic data for improving risk detection precision in the terminal device 1, and cause the basic data to be used by the terminal device 1.

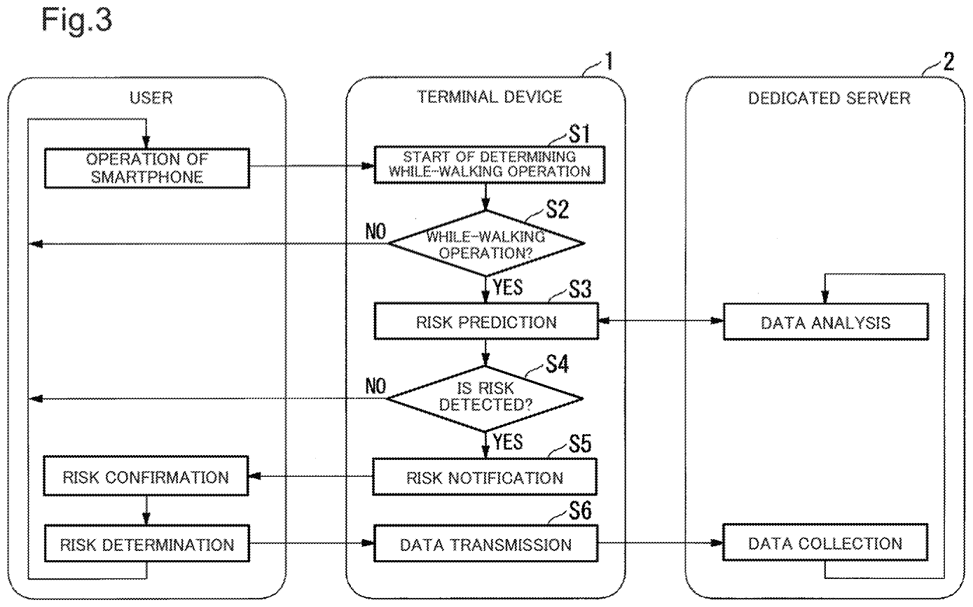

FIG. 3 is a diagram illustrating a processing flow of the terminal device.

Next, operation of the terminal device 1 is described with reference to FIG. 3.

The processing of the terminal device 1 is processing of predicting a risk and notifying the user of the prediction result when the terminal device 1 detects that the user is making operation while walking, and one example thereof is described.

The terminal device 1 is communicatively connected to a dedicated server 2. The dedicated server 2 includes a function of receiving results of risk prediction and risk detection of the terminal device 1, and collecting and analyzing characteristics of data such as image data used for detecting a risk, and feedback information from all users.

First, the while-walking operation determination unit 12 of the terminal device 1 starts processing of determining whether a user is making operation while walking (step S1). Then, the while-walking determination unit 12 combines various functions such as the acceleration sensor 109, and determines whether the user who operates the terminal device 1 is making operation while walking (step S2). For example, the while-walking operation determination unit 12 determines whether the screen constituting a touch panel is in an on-state and is operated, whether a motion pattern detected by the acceleration sensor 109 matches a walking pattern, and whether a characteristic point specified in image data acquired from the camera 108 is moving. When the screen is in an on-state, and an acceleration pattern from the acceleration sensor 109 matches the walking pattern, the while-walking operation determination unit 12 may determine that the user is walking. Further, when a characteristic of a face of the user is included in the image data acquired from the camera 108, and a position of this characteristic point is moving in the successively acquired image data, the while-walking operation determination unit 12 may determine that the terminal device 1 is being operated while walking. This example of determination of operation while walking is one example, and determination of operation while walking may be performed by another method.

The risk prediction unit 13 starts processing of predicting and detecting a risk to a user by using the camera and various sensors (step S3). Then, the risk prediction unit 13 determines whether or not a risk is detected (step S4).

The risk prediction unit 13 specifies an advancing direction of the user carrying the terminal device 1 by using the acceleration sensor 109 or the like. Further, the risk prediction unit 13 detects an inclination of the terminal device 1, based on information acquired from the acceleration sensor 109. For example, when the terminal device 1 is plate-shaped, the risk prediction unit 13 detects an inclination (forward inclination angle) in an orthogonal-to-surface direction in a reference state where the plate-shaped terminal device 1 is made to vertically stand, and an inclination (lateral inclination angle) in a direction orthogonal to the orthogonal-to-surface direction. Note that the forward inclination angle represents a degree by which the terminal device 1 is inclined in the orthogonal-to-surface direction (corresponding to an advancing direction of the user) from a state of being orthogonal to the ground surface (when the forward inclination angle is 90°, the terminal is in a horizontal state). The lateral inclination angle represents a degree by which the terminal device 1 is inclined toward the right side from the advancing direction (when the lateral inclination angle is 90°, an upper portion of the terminal device 1 is directed toward the right side and is completely lateral relative to the advancing direction).

When it is determined that operation while walking is being made, the in-camera 108a or the out-camera 108b acquires several to several tens of images in one second by the control unit 11 and outputs the images to the risk prediction unit 13. The risk prediction unit 13 acquires the image data from the in-camera 108a (or the out-camera 108b). The risk prediction unit 13 detects a difference between the image data newly acquired by image shooting of the in-camera 108a (or the out-camera 108b) and a plurality of pieces of image data acquired by immediately preceding image shooting from among the image data acquired from the in-camera 108a (or the out-camera 108b) in a fixed period of time. In this difference, the risk prediction unit 13 performs correction of excluding an object appeared in the current image data due to camera shake or walking vibration in the image, based on the forward inclination angle and the lateral inclination angle, and determines whether a risk object candidate is included in the image of the un-excluded portion.

When a user is viewing the touch panel 106 while walking, the out-camera 108b basically shoots an image in front of the user, but when the user horizontally holds the touch panel 106 of the terminal device 1 in such a way as to be oriented in the sky direction, a forward inclination angle is close to 90°. In this case, the out-camera 108b provided in the terminal device 1 shoots an image of the ground in a state of being substantially horizontal, and it becomes difficult to shoot an image on the front side, and for this reason, risk prediction can be performed by using an image complemented by the in-camera 108a or an external camera such as an all-sky camera.

In analysis of image data acquired from the in-camera 108a, an object behind and over the user can be detected, and thus, the risk prediction unit 13 can widen a risk search area. Thereby, the risk prediction unit 13 can detect an approaching object and a risk object from a back side of the user, and a falling object overhead. Further, with the in-camera 108a, a line-of-sight direction of the user can be also recognized, and a risk can be predicted by detecting the line-of-sight direction. For example, the risk prediction unit 13 detects approaching of a car toward the user, based on image data acquired by image shooting with the out-camera 108b. Further, the risk prediction unit 13 detects the line-of-sight direction of the user, based on image data acquired by image shooting with the in-camera 108a. The risk prediction unit 13 predicts a risk when determining that the line-of-sight direction is not oriented to a car even though the car is approaching the user.

In one example of this specific processing, the risk prediction unit 13 detects, by pattern recognition, a car included in a plurality of successive image data acquired from the out-camera 108b. The risk prediction unit 13 calculates a direction vector oriented from the terminal device 1 to the car in a three-dimensional space coordinate system, based on a position of the car included in the image data, and an orientation of the back surface of the terminal device 1 based on an acceleration acquired from the acceleration sensor 109. The risk prediction unit 13 detects a current line-of-sight direction of the user, based on stored positional relations between a white region and a black region of the user's eye included in successive image data acquired from the in-camera 108a, also based on information of line-of-sight directions corresponding to the positional relations between the white region and the black region. The white region is represented by a conjunctival region and the black region represented by a iris or pupil region in an eye of the user. The risk prediction unit 13 calculates a line-of-sight vector represented by the line-of-sight direction in the three-dimensional space coordinate system. The risk prediction unit 13 calculates an angle made by a first direction vector oriented to the car from the terminal device 1 and the line-of-sight vector. When the angle made by the first direction vector and the line-of-sight vector is equal to or larger than a predetermined angle, the risk prediction unit 13 determines that the line-of-sight direction of the user is not oriented to the car.

The risk prediction unit 13 may estimate a moving risk object candidate based on a difference between shot images. In this case, the risk prediction unit 13 acquires positional information previously measured by the GPS 111, for example, and estimates a moving speed of the user. Further, the risk prediction unit 13 determines whether the risk object candidate itself is moving, from size change of the moving risk object candidate in the images. The risk prediction unit 13 determines whether the risk object candidate is approaching or moving away from the terminal device 1 held by the user. Alternatively, the risk prediction unit 13 determines whether only the user is moving and thereby, the risk object candidate merely appears to be moving.

In a specific example of the processing in this case, for example, the risk prediction unit 13 calculates a walking speed and a walking direction of the user holding the terminal device 1, based on positional information that depends on elapsing of time and that is acquired from the GPS 111. Further, the risk prediction unit 13 stores a per-unit-time change rate of a size of a risk object candidate included in images, in association with a walking speed, and acquires information of the change rate. The risk prediction unit 13 calculates a per-unit-time change rate of a size of a risk object candidate included in image data successively acquired from the in-camera 108a or the out-camera 108b, and determines whether a per-unit-time change rate is higher than a change rate associated with a walking speed of the user. When the per-unit-time change rate of the size of the risk object candidate included in image data is higher than the change rate associated with the walking speed of the user, the risk prediction unit 13 determines that the risk object candidate is approaching.

Further, the risk prediction unit 13 may extract a reference mark included in the acquired image data, may estimate a size of the risk object candidate from a per-unit-time change rate of a size of information representing the mark, and may calculate a moving speed of the risk object candidate by using the estimated size of the risk object candidate. Here, the reference mark is an object having a relatively fixed size such as a sign and a postbox.

The risk prediction unit 13 can estimate a size of a person riding a bicycle from a relative size thereof by using, as a reference mark, an object such as a traffic light or a postbox that is installed at regular intervals in a street and have a size relatively fixed. By such a method, the risk prediction unit 13 may calculate a size of a risk object candidate in an image, and for example, may estimate a distance between a person riding the bicycle and a user, and an approaching speed, and may calculate predicted collision time.

In determination of a risk object candidate made by the risk prediction unit 13, a risk object candidate can be determined by other methods.

For example, the risk prediction unit 13 stores, as risk object candidates, shapes of a pedestrian crossing, a traffic light, braille and linear blocks for visually handicapped persons on a platform of a station and a road, a pedestrian, a bicycle, a step, a road surface abnormality, a utility pole, a signboard, a street stall, a small animal, and the like. The risk prediction unit 13 performs pattern matching between the stored shape information and objects acquired from a shot image, and determines which of the stored shapes matches the objects. When determining that the shapes match the objects by the pattern matching, the risk prediction unit 13 recognizes, as risk object candidates, the objects included in the image. The risk prediction unit 13 determines whether or not approaching to these risk object candidates progresses, by comparing the preceding image data with subsequent image data.

The risk prediction unit 13 may previously estimate a moving speed of a user by using a movement amount per unit time based on positional information acquired from the GPS 111, and may determine whether or not approaching progresses, based on comparison between the moving speed with a per-unit-time change rate of a size of the risk object candidate included in the images.

The risk prediction unit 13 may joint pieces of image data acquired sequentially for several seconds and combine them. In this case, the risk prediction unit 13 can discriminate a risk object candidate, with a wider viewpoint beyond an instantaneous area whose image can be shot by the camera.

Further, the risk prediction unit 13 may acquire image data from an external camera such as a camera of a wearable terminal and a 360-degree camera (all-sky camera) other than the in-camera 108a and the out-camera 108b attached to the terminal device 1. The terminal device 1 may be equipped with a plurality of cameras.

As another method in which the risk prediction unit 13 detects approaching of a risk object candidate, a person riding a bicycle is detected as a risk object candidate from image data. The risk prediction unit 13 extracts change pixels on a camera image, from a difference between an image frame Ft at that time and one or more immediately preceding image frames Ft-1 (that are not limited to one immediately preceding frame and may be a plurality of the immediately preceding frames). When the risk prediction unit 13 can determine that a region of the pixels representing the risk object candidate increases, the risk prediction unit 13 determines that the risk object candidate is approaching.

When the risk prediction unit 13 estimates an advancing direction of the person riding the bicycle and determines the approaching progresses to a left side of a user holding the terminal device 1, by escaping to a right side, the user can avoid collision with the person riding the bicycle. Accordingly, the risk prediction unit 13 displays information for prompting escape to the right side, and thereby makes the notification to the user. For example, the risk prediction unit 13 outputs, with an arrow, the direction for the risk avoidance action. At this time, from the image data, the risk prediction unit 13 may detect whether or not a room to which the user can escape exists in the direction of the risk avoidance action.

The risk prediction unit 13 may predict a risk, based on a sound signal acquired from the microphone 110.

For example, by analyzing the sound signal acquired from the microphone 110, a characteristic sound is detected. For example, a characteristic sound is a siren, a sound of a traffic signal that makes notification of a crossing period of time, a sound at the time of closing of a railroad crossing, a bicycle bell, or the like. Since such artificial warning sounds emitted to a person is regularly repeated in many cases, the risk prediction unit 13 previously stores waveform patterns of the sounds, and predicts that a risk exists when determining a sound waveform pattern acquired from an acquired sound signal matches the previously stored waveform pattern of the warning sound. There is no limitation to artificial warning sounds, and the risk prediction unit 13 may perform audio recognition of a voice of a person such as “danger” and “run away”, and may determine that a risk object candidate is closely approaching when determining a word acquired by the audio recognition matches a previously stored word representing a warning.

The terminal device 1 may be provided with a plurality of the microphones 110, and the risk prediction unit 13 may specify a direction of a sound generation source, based on a sound signal acquired from each of the microphones 110 and a posture of the terminal device 1. More specifically, the risk prediction unit 13 analyzes the sound signal acquired from each of the microphones 110, and calculates an intensity of the sound. Based on the intensity of the sound acquired from each of the microphones 110, the risk prediction unit 13 estimates the direction of the sound generation source, with the terminal device 1 being used as reference for the direction. The risk prediction unit 13 specifies a direction vector of the sound generation source in a three-dimensional space coordinate system represented by three axes that are orthogonal to each other and that are used as reference based on a current posture of the terminal device 1. The risk prediction unit 13 detects an object in the shot image corresponding to the direction represented by the specified direction vector of the generation source. When the object is specified as a risk object candidate by recognizing a pattern such as a shape, the risk prediction unit 13 makes a link of a relation between the risk object candidate and the direction vector of the generation source. When the risk object candidate matches the direction vector of the generation source, the risk prediction unit 13 may output the direction of the risk object candidate from a speaker by voice, for example.

Next, the notification unit makes notification of risk information (step S5).

The following specifically describes processing of the notification unit 14. The notification unit 14 notifies a user of detected risk information. For example, the notification unit 14 displays, as the risk information, a detected risk object candidate and information related thereto on the screen of the terminal device 1. At this time, the notification unit 14 may also display the predicted collision time, based on the risk approach level representing whether the risk is imminent. The notification unit 14 may also display information for assisting a user in taking a risk avoidance action, based on an orientation (posture) of the terminal device 1 and an approaching direction of the risk object candidate.

Note that the time of notifying a user of risk information is not limited to the time that a risk is predicted, and information indicating a possibility of a risk in image data acquired by image shooting of the camera 108 or indicating a possibility of a characteristic sound in the microphone 110 may be displayed on a part of the screen in real time.

The notification unit 14 may make the notification by selectively using the various output functions provided in the terminal device 1 such as the speaker 112, the vibrator 113, and the light 114 as well as the screen display, based on an orientation (posture) of the terminal device 1 and a line-of-sight direction of the user.

The following is the supplementary description on notification processing of risk information at the step S5.

Note that when risk information is displayed on the screen, the output is made with a risk approach level being set as one of a level 1 to a level 3. In one example, the risk approach level 3 is set for three seconds before predicted collision time, but a risk avoidance action depends partially on an age and physical ability of a user, and thus, the setting may depend on a user in such a way as not to be a fixed value.

### Risk Approach Level 1

The risk prediction unit 13 calculates a distance between a detected risk object candidate and the terminal device 1, and determines the risk approach level as the level 1 when determining that the distance is equal to or longer than a threshold value. When determining that the distance to the risk object candidate is equal to or longer than the threshold value and that an approaching speed of the risk object candidate is lower than a threshold value or the risk object candidate is stationary, the risk prediction unit 13 determines the risk approach level as the level 1. In one example, when the calculated distance is equal to or longer than the threshold value, and the approaching speed is lower than the threshold value, and thus, predicted time before collision with the user is equal to or longer than eight seconds, the risk prediction unit 13 determines the risk approach level as the level 1.

### Risk Approach Level 2

When determining that the distance to the risk object candidate is equal to or longer than the threshold value and that the approaching speed of the risk object candidate is equal to or higher than the threshold value, the risk prediction unit 13 determines the risk approach level as the level 2. In one example, when the calculated distance is equal to or longer than the threshold value, but the approaching speed is equal to or higher than the threshold value, and thus, predicted time before collision with the user is eight seconds to three seconds, the risk prediction unit 13 determines the risk approach level as the level 2.

### Risk Approach Level 3

When determining that the distance to the risk object candidate is shorter than the threshold value and that the approaching speed of the risk object candidate is equal to or higher than the threshold value, the risk prediction unit 13 determines the risk approach level as the level 3. In one example, when the calculated distance is shorter than the threshold value, and in addition, the approaching speed is equal to or higher than the threshold value, and thus, predicted time before collision with the user is smaller than three seconds, the risk prediction unit 13 determines the risk approach level as the level 3.

In determination of the risk approach level, the risk prediction unit 13 may make the determination by using one or a plurality of pieces of information among a position of a risk object candidate determined from image data, a size thereof, a change amount when the risk object candidate approaches a user in unit time, an approach distance to a user, and predicted collision time.

When calculating the predicted collision time, the risk prediction unit 13 can calculate a change region by detecting a frame difference of image data at fixed intervals of the acquisition, and can estimate a moving distance and a moving speed (approaching speed) of a risk object candidate, based on the change region.

Based on an advancing direction of a risk object candidate and a direction of a sound detected via the microphone 110, the risk prediction unit 13 may output, by audio or the screen, auxiliary information such as where to escape for a risk avoidance action. For example, the risk prediction unit 13 displays, on the screen, with an arrow, a direction in which a user should escape.

Note that since a risk object candidate does not always emit a sound, the risk prediction unit 13 may process a sound signal as input information acquired from the microphone 110 and image data acquired from the camera 108, independently of each other, and may set priority or a weighting to one of the sound signal and the image data. Further, as described above, in the analysis of the image data from the camera 108, a posture such as an inclination (a forward inclination angle or a lateral inclination angle) of the terminal can be calculated based on an acceleration acquired from the acceleration sensor 109, an advancing direction can be recognized, and image distortion due to shake and movement of the terminal can be complemented.

The following is the supplementary description on the notification means of risk information at the step S5.

Based on inclination information, the risk prediction unit 13 of the terminal device 1 detects that the screen portion of the terminal device 1 is oriented in a ground direction and cannot be viewed by a user. Since the risk prediction unit 13 can determine that there is a high possibility that the user cannot make recognition only by the notification to the screen, the risk prediction unit 13 selects a different notification means such as the vibrator 113, the speaker 112, and the light 114, and thereby notifies the user of a risk. Further, when the risk prediction unit 13 detects that the user is not viewing the screen based on a line-of-sight information of the user, the notification unit 14 may select the notification means, and may thereby notify the user of the risk.

The data transmission unit 15 transmits data concerning a detected risk to the dedicated server (step S6). Note that the dedicated server may collect feedback and risk prediction results from all users, and may diversely analyze and accumulate the data, and may thereby perform processing of improving risk prediction precision for all terminal devices 1 including not only the present terminal device 1 but also other terminal devices 1. The terminal device 1 may perform risk prediction, based on the data analysis acquired from the dedicated server 2.

Further, in the case of an actual risk, there is a case where operation of a user not only makes the feedback to that effect, but also calls the police and a hospital after avoiding the risk, shoots an evidence photo, and sends a detected result to social networking service (SNS) and registers the result. Assuming that a user takes those actions at a high possibility at the risk location, the dedicated server may receive the feedback as to whether or not the user has taken those actions.

According to the processing of the above-described terminal device 1, for risk detection when the user is operating the terminal device 1 while walking, it is possible to provide a mechanism that detects a risk object candidate such as an obstacle or an approaching object by using the out-camera 108b, and using also the in-camera 108a, depending on necessity. Thereby, the terminal device 1 can perform detailed risk prediction. Further, the terminal device 1 can also use information such as an inclination from the acceleration sensor 109 and information such as sounds and a direction from a plurality of the microphones 110, and can thereby predict a risk that is not included in the camera 108.

In risk prediction, the terminal device 1 may use data acquired in cooperation with a wearable terminal such as a watch-type terminal and a glasses-type terminal.

The above-described terminal device 1 includes a computer system inside. Each step of the above-described processing is stored in a computer-readable recording medium in the form of a program, and a computer reads out and executes the program, thereby performing the above-described processing. Here, the computer-readable recording medium denotes a magnetic disk, a magneto-optical disk, a CD-ROM, a DVD-ROM, a semiconductor memory, or the like. Alternatively, the computer program may be distributed to the computer via a communication line, and the computer that has received the distribution may execute the program.

The program may be one for implementing a part of the above-described functions. Further, the program may be what is called a differential file (differential program) that can implement the above-described functions by being combined with a program already recorded in the computer system.

This application is based upon and claims the benefit of priority from Japanese patent application No. 2017-146960, filed on Jul. 28, 2017, the disclosure of which is incorporated herein in its entirety by reference.

### REFERENCE SIGNS LIST

1 Terminal device
2 Dedicated server
11 Control unit
12 While-walking operation determination unit
13 Risk prediction unit
14 Notification unit
15 Data transmission unit
101 CPU
102 ROM
103 RAM
104 HDD
105 Communication module
106 Touch panel
107 Input-output unit
108 Camera
109 Acceleration sensor
110 Microphone
111 GPS
112 Speaker
113 Vibrator
114 Light

1. A terminal device comprising:
a while-walking operation determination unit for determining whether a user is operating an own device while walking;
a sound collection device that collects a surrounding sound; and
a risk prediction unit for, when it is determined that the user is operating an own device while walking, predicting a risk to the user, based on a risk object candidate included in image data acquired from a camera provided in an own device, wherein
the risk prediction unit calculates a direction of a generation source of the sound, based on a sound signal acquired from the sound collection device.

2. The terminal device according to claim 1, wherein
the risk prediction unit detects a posture of the terminal device, and selects
notification unit to be used for notification of a risk, based on the posture, when predicting a risk to the user.

3. 1 The terminal device according to claim 1, further comprising:
an in-camera, as the camera, provided in a main surface of a plate-shaped housing of the terminal device; and
an out-camera provided in a back surface opposite to the main surface, wherein
the risk prediction unit predicts a risk to the user, based on images acquired from both of the in-camera and the out-camera.

4. A risk prediction method comprising:
determining whether a user is operating an own device while walking;
collecting a surrounding sound; and,
when it is determined that the user is operating an own device while walking, predicting a risk to the user, based on a risk object candidate included in image data acquired from a camera provided in a terminal device, and calculating a direction of a generation source of the sound, based on a signal of the collected sound.

5. A recording medium that stores a program causing a computer of a terminal device to function as:
a while-walking operation determination unit for determining whether a user is operating an own device while walking;
a sound collection unit for collecting a surrounding sound; and
a risk prediction unit for, when it is determined that the user is operating an own device while walking, predicting a risk to the user, based on a risk object candidate included in image data acquired from a camera provided in the terminal device, and calculating a direction of a generation source of the sound, based on a signal of the collected sound.

6. The terminal device according to claim 2, further comprising:
an in-camera, as the camera, provided in a main surface of a plate-shaped housing of the terminal device; and
an out-camera provided in a back surface opposite to the main surface, wherein
the risk prediction unit predicts a risk to the user, based on images acquired from both of the in-camera and the out-camera.
